(19) United States
(12) Patent Application Publication
(10) Pub. No.: US 2009/0081917 A1
(43) Pub. Date: Mar. 26, 2009

(54) COMBINATION NOVELTY BALLOON AND BAG

(75) Inventor: Robert E. Greenwald, Coon Rapids, MN (US)

Correspondence Address: BRIGGS AND MORGAN P.A., 2200 IDS CENTER, 80 SOUTH 8TH ST, MINNEAPOLIS, MN, 55402, US

(73) Assignee: Anagram International, Inc., Eden Prairie, MN (US)

(21) Appl. No.: 12/182,243

(22) Filed: Jul. 30, 2008

Related U.S. Application Data
(60) Provisional application No. 60/974,933, filed on Sep. 25, 2007.

(51) Int. Cl. A63H 33/00; A63H 3/06; B65D 33/04; B31B 1/64; B31B 1/00; B31B 49/00

(52) U.S. Cl. 446/74; 446/226; 383/106; 493/189; 493/267; 493/381

(57) ABSTRACT

An inflatable, non-latex balloon with an attached bag for holding items. The balloon with attached bag has an inflatable portion and a non-inflatable portion. The inflatable portion or balloon is inflatable with air or gas, while the non-inflatable portion forms a bag for holding items. The balloon and bag are preferably constructed unitarily from sheets of heat-sealable film. The bag may be closed as for example by a tie. The bag may be either opaque, translucent, or transparent.

### BACKGROUND OF THE INVENTION

The present invention relates generally to non-latex balloons and more particularly to a non-latex balloon having an attached bag for holding of various items.

Non-latex balloons have been popular for many years. Non-latex balloons, often referred to as metallized balloons, are characterized as balloons that are comprised of materials that have no elastic properties. Such materials include plastic, foil, mylar, and nylon. A variety of non-latex balloons have been made available to the public, including brightly colored, transparent, and even multi-layered balloons. Further, balloons which centrally house various materials have been produced. See, for example, U.S. Pat. Nos. 5,338,243, 4,837,955, 5,254,026 and U.S. Pat. No. 5,108,339 the teachings thereof which are herein incorporated by reference. Further, a self-sealing valve has been introduced, which allows the balloon to be easily and quickly inflated and further eliminates the need for tying or heat-sealing of the balloon stem. See U.S. Pat. No. 4,917,646 and the teachings thereof which are incorporated herein by reference.

U.S. Pat. No. 4,837,955 discloses a display unit for housing an exhibit and a chamber unit for housing the display unit. An aperture permits an exhibit to be inserted into the display unit from outside the chamber unit. The display unit is suspended inside the chamber unit. The chamber unit is filled with a gas.

U.S. Pat. No. 5,108,339 discloses a first inner balloon encompassed by a partially transparent second outer balloon.

U.S. Pat. No. 5,254,026 discloses a display device having a pocket within a balloon to hold a removable item and display the item through the balloon.

None of the above references discloses a combination balloon and bag, with the bag spatially outside the balloon. Rather, a pocket (U.S. Pat. Nos. 4,837,955 and 5,254,026) is spatially within the interior of a balloon. Because the gas within the balloon exerts pressure on the pocket, a limit is imposed on the size of an object that can be housed within the pocket. Also, in the case of U.S. Pat. No. 4,837,955, no way to close the pocket is disclosed. U.S. Pat. No. 5,254,026 does disclose a pocket flap to close the pocket, but having such a flap increases the manufacturing cost of the item.

There is a need for an inflatable, non-latex balloon with an attached bag for holding items. The attached bag should be spatially exterior to the balloon, in order to maximize the number and types of articles that may be placed therein. The bag should be closable by a simple tie.

### SUMMARY OF THE INVENTION

An inflatable, non-latex balloon with an attached bag for holding items. The balloon with attached bag has an inflatable portion and a non-inflatable portion. The inflatable portion or balloon is inflatable with air or gas, while the non-inflatable portion forms a bag for holding items. The balloon and bag are preferably constructed unitarily from sheets of heat-sealable film. The bag may be closed as for example by a tie. The bag may be either opaque, translucent, or transparent.

A principle object and advantage of the present invention is that it combines a bag for holding items with a decorative balloon, in a single piece.

Another principle object and advantage of the present invention is that it lowers manufacturing costs by forming the balloon and bag unitarily out of layers of heat-seal film.

Another principle object and advantage of the present invention is that the bag is spatially exterior to the balloon, thereby maximizing the number and types of articles that may be placed in the bag.

### BRIEF DESCRIPTION OF DRAWINGS

FIG. 1 is a perspective view of one embodiment of the present invention.

FIG. 2 is a perspective view of another embodiment of the present invention.

FIG. 3 is an elevational view of the embodiment of FIG. 2 in an un-inflated state.

FIG. 4 is a cross-section taken at approximately the lines 4 of FIG. 3.

FIG. 5 is a cross-section taken at approximately the lines 5 of FIG. 3.

### DETAILED DESCRIPTION OF THE PREFERRED EMBODIMENT

The present invention is generally shown in the Figures as reference numeral 10.

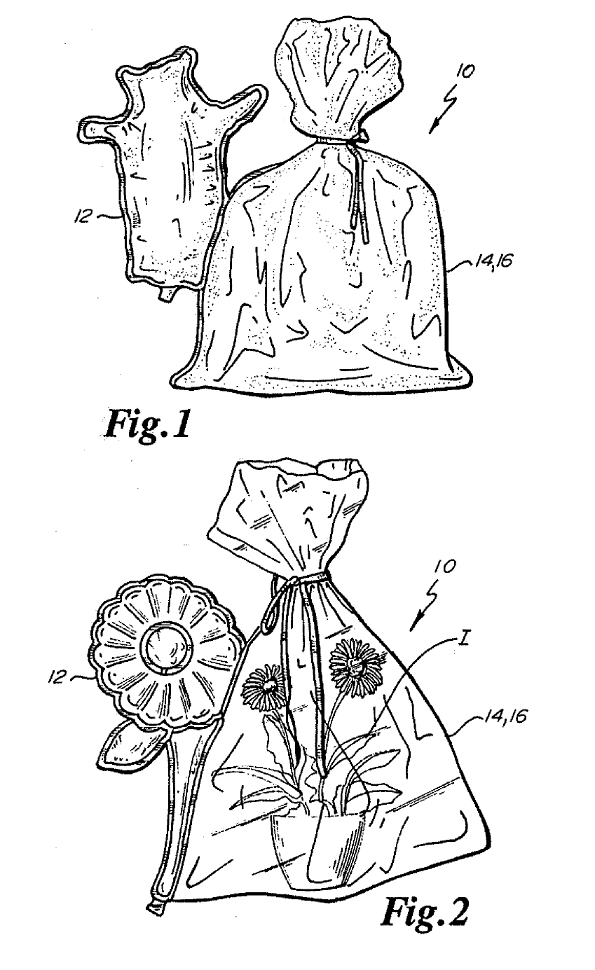

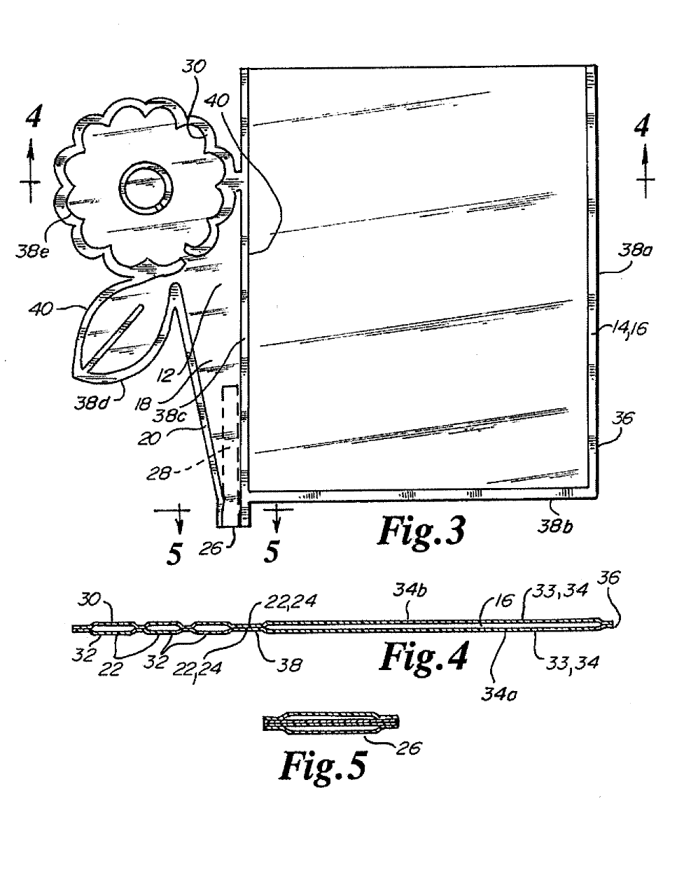

As shown in FIGS. 1 and 2, the present invention comprises an inflatable portion 12 and a non-inflatable portion 14. FIG. 1 shows that the present invention 10 may be opaque. Alternatively, FIG. 2 shows that the present invention may be translucent or transparent, so that an item I may be visible within the invention 10.

Preferably, the non-inflatable portion 14 further comprises a bag 16 for holding items I.

The inflatable portion 12 further comprises an inflatable interior 18 within a wall 20. The wall 20 comprises a plurality of layers 22 of heat-sealable film 24. The wall 20 is constructed and the inflatable interior 18 is formed by heat-scaling the layers 22 at edges therein as is known in the art.

The inflatable portion 12 further comprises an inflation port 26 for connection to an external source of inflation fluid, such as air or gas, and a self-sealing valve 28. The self-sealing valve 28 is in communication with the interior 18 for inflation of the interior 18.

The inflatable portion 12 may preferably further comprise a secondary inflatable portion 30 in communication with the interior 18 through apertures 32, allowing inflation of the secondary inflatable portion 30.

The non-inflatable portion further comprises a plurality of layers 33 of heat-sealable film 34, which are sealed at edges 36 to form the bag 16.

Preferably, the inflatable portion 12 and the non-inflatable portion 14 share a common heat-sealed edge 38. In this manner, the inflatable portion 12 and non-inflatable portion 14 may be manufactured unitarily from layers of heat-seal film.

Preferably, the non-inflatable portion 14 is spatially exterior to the inflatable portion 12, as shown in the drawings.

In a second aspect, the present invention is a combination inflatable, non-latex balloon 10 with a non-inflatable attached bag 16. The invention comprises a first sheet 34a of heat-sealable film and a second sheet 34b of heat-sealable film. The first sheet 34a is heat-sealed to the second sheet 34b along three extents, 38a, 38b, and 38c, thereby forming an open, non-inflatable portion 14 adapted to receive an item. The first sheet 34a is also heat-sealed to the second sheet 34b along a fourth extent 38d. The fourth extent 38d and one of the first three extents 38c comprise walls 40 encompassing the inflatable portion 12. The self-sealing valve 28 is heat-sealed between the first sheet 34a and the second sheet 34b and is in flow communication with the inflatable portion 12 for inflating the inflatable portion 12 with a fluid such as a gas. As seen in the drawings, the non-inflatable portion 14 is spatially exterior to the inflatable portion 12.

The inflatable portion 12 may preferably farther comprise a secondary inflatable portion 30 in communication with the interior 18 through apertures 32, allowing inflation of the secondary inflatable portion 30.

In another aspect, the present invention is a method of manufacturing a combination inflatable, non-latex balloon with a non-inflatable attached bag, comprising the steps of:

a) heat-sealing a first sheet 34a of heat-sealable film to a second sheet 34b of heat-sealable film along three extents 38a, 38b, and 38c, thereby forming an open, non-inflatable portion 14 adapted to receive an item;

b) heat-sealing the first sheet to the second sheet along a fourth extent 34d, the heat-sealed portion of one of the three extents 34c and the fourth extent 34d comprising walls 40 encompassing an inflatable portion 12, the non-inflatable portion 14 remaining exterior to the inflatable portion 12; and

c) heat-sealing a self-sealing valve 28 between the first sheet and the second sheet, the valve being in flow communication with the inflatable portion.

The above method may also preferably comprise a step of heat-sealing the first sheet to the second sheet along a fifth extent 38, thereby creating a secondary inflatable portion 30 in flow communication with the inflatable portion.

The present invention may be embodied in other specific forms without departing from the spirit or essential attributes thereof, and it is therefore desired that the present embodiment be considered in all respects as illustrative and not restrictive.

What is claimed:

1. A combination inflatable, non-latex balloon with a non-inflatable attached bag, comprising:
a.) an inflatable portion;
b.) a valve portion in flow communication with the inflatable portion; and
c.) a non-inflatable portion exterior to the inflatable portion, the non-inflatable portion further comprising a bag with an opening adapted to receive an item.

2. The combination balloon and bag of claim 1, wherein the inflatable portion further comprises a first edge and the non-inflatable portion further comprises a second edge, the second edge being sealed to the first edge.

3. The combination balloon and bag of claim 1, wherein the bag is substantially transparent.

4. The combination balloon and bag of claim 1, wherein the bag is substantially translucent.

5. The combination balloon and bag of claim 1, wherein the bag is substantially opaque.

6. The combination balloon and bag of claim 1, further comprising a secondary inflatable portion in flow communication with the inflatable portion.

7. A combination inflatable, non-latex balloon with a non-inflatable attached bag, comprising:
a.) a first sheet of heat-sealable film;
b.) a second sheet of heat-sealable film; and
c.) a self-sealing valve;
i.) wherein the first sheet is heat-sealed to the second sheet along three extents, thereby forming an open, non-inflatable portion adapted to receive an item; and
ii.) wherein the first sheet is heat-sealed to the second sheet along a fourth extent, the heat-sealed portion of one of the first three extents and the fourth extent further comprising walls encompassing an inflatable portion, the self-sealing valve being heat-sealed between the first sheet and the second sheet in flow communication with the inflatable portion;
iii.) the non-inflatable portion being spatially outside the inflatable portion.

8. The combination balloon and bag of claim 1, further comprising a secondary inflatable portion in flow communication with the inflatable portion, the secondary inflatable portion being formed by heat-sealing the first sheet to the second sheet along a fifth extent.

9. A method of manufacturing a combination inflatable, non-latex balloon with a non-inflatable attached bag, comprising the steps of:
a.) heat-sealing a first sheet of heat-sealable film to a second sheet of heat-sealable film along three extents, thereby forming an open, non-inflatable portion adapted to receive an item;
b.) heat-sealing the first sheet to the second sheet along a fourth extent, the heat-sealed portion of one of the three extents and the fourth extent comprising walls encompassing an inflatable portion, the non-inflatable portion remaining exterior to the inflatable portion; and
c.) heat-sealing a self-sealing valve between the first sheet and the second sheet, the valve being in flow communication with the inflatable portion.

10. The method of claim 9, further comprising the step of heat-sealing the first sheet to the second sheet along a fifth extent, thereby creating s secondary inflatable portion in flow communication with the inflatable portion.
